(19) United States
(12) Patent Application Publication
(10) Pub. No.: US 2025/0347548 A1
(43) Pub. Date: Nov. 13, 2025

(54) DEVICE AND METHOD FOR MEASURING PHYSICAL QUANTITIES OF A CONTAINER BY A TIME-OF-FLIGHT SENSOR

(71) Applicant: STMicroelectronics International N.V., Geneva (CH)

(72) Inventors: Olivier Lemarchand, Grenoble (FR); Roger Monteith, Edinburgh (GB); Robin Vassal, Grenoble (FR); Herve Grotard, Aix-en-Provence (FR)

(21) Appl. No.: 19/198,778

(22) Filed: May 5, 2025

(30) Foreign Application Priority Data
May 7, 2024 (FR) FR2404794

(51) Int. Cl. G01F 23/292; B67D 3/00; G01B 11/06

(52) U.S. Cl. CPC G01F 23/292; B67D 3/0003; G01B 11/0608

(57) ABSTRACT

According to one aspect, a method is provided for measuring a physical quantity of a container placed in a detection area, using a time-of-flight sensor. The method comprises, using a processor, receiving a histogram or a matrix of histograms generated from a light pulse emitted by a time-of-flight sensor and reflected by the container, each histogram being formed of bins corresponding to distinct times of flight, extracting, for each histogram, a first histogram bin that indicates a pulse rising edge, so as to obtain a matrix of first histogram bins, and determining the height, the diameter, the position of the container and/or the filling height of the container from the matrix of first histogram bins.

### CROSS-REFERENCE TO RELATED APPLICATIONS

This application claims the benefit of French Patent Application No. FR2404794, filed on May 7, 2024, which application is hereby incorporated herein by reference.

### TECHNICAL FIELD

Embodiments and implementations relate to object measurement devices and methods, in particular for measuring a physical quantity related to an object in a detection area by a time-of-flight sensor.

### BACKGROUND

Time-of-flight (ToF) imagers, also called ToF sensors, have been widely used recently for various applications, such as face and gesture recognition, light detection and ranging (LiDAR), virtual reality, augmented reality and autonomous robotics, because of their low cost compared to other sensors such as cameras. A ToF telemetry system uses a ToF imager to measure the distance of an object (for example, a target). To measure an object, the ToF telemetry system asks the ToF sensor to send a light signal (for example, light pulses such as a laser or an infrared light) towards the object and measures the time needed by the signal to reach the object and return back to the ToF imager.

A single-photon avalanche diode (SPAD) may be used as a reflected light detector. In some applications, a network or array of SPADs is provided as a sensor (hereinbelow SPAD array) in order to detect a reflected light pulse. A reflected photon could generate a carrier wave in the SPAD by photoelectric effect. The carrier wave generated by the photon could trigger an avalanche current in one or more SPAD(s) of a SPAD array. The avalanche current could signal an event, namely that a photon has been detected. The information relating to the reflected intensity, some kind of a signal counter, is emitted in the form of a matrix of histograms corresponding to the SPAD array. The histogram of each SPAD comprises a plurality of groups of histogram intervals or classes or cells or “bins”, where each histogram bin corresponds to a travel time or to a distance (more specifically, to a narrow time or distance range) of the SPAD array, and the value (for example, the number of signals) of each histogram bin corresponds to the number of detected avalanche current events (for example, the number of detected photons).

The histogram of a SPAD should be processed to extract useful information therefrom, such as the number of detected targets, the distances of the targets, etc.

ToF sensors are used to determine the presence of a container under a dispenser of a product such as a liquid. A typical use relates to the determination of the presence of a cup or the like under a beverage dispenser (for example, a coffee machine). For example, this determination allows automatically monitoring pouring of the beverage only in the presence of a cup.

Additional improvements, such as an automatic monitoring of the volume to be poured or the automatic stoppage of pouring when the container is full, require the determination of other physical quantities relating to the container. The height of the container and/or its filling level are useful examples.

Nevertheless, ToF sensors are not suited to the accurate determination of such physical quantities in the presence of reflective containers, such as containers made of glass or of a polished material.

For example, the useful signal for determining the height of a cup, namely that one of the photons reflected by the upper rim of the cup, turns out to be very low compared to the total signal received at each SPAD. Indeed, a few photons are reflected by the upper rim and received in return by the SPAD (and more generally the ToF sensor), in particular because of the small thickness of the cup, while a very large number of photons emitted towards the cup are received by the SPAD with an extended time-of-flight, because of their multiple reflections inside the cup.

### SUMMARY

Therefore, there is a tendency for an overestimation of the measured distances, and consequently for a prejudicial underestimation of the height of the cup.

Hence, there is a need to improve the time-of-flight (ToF) techniques for measuring physical quantities, which are applicable not only to reflective containers but also to any type of containers.

According to one aspect, a method is provided for measuring a physical quantity of a container placed in a detection area, using a time-of-flight sensor, the method comprising, using a processor, receiving at least one histogram generated from a light pulse emitted by a time-of-flight sensor and reflected by the container, the histogram being formed of classes so-called “bins” corresponding to distinct times of flight, extracting, from the histogram, a first histogram bin that indicates a pulse rising edge, and determining the physical quantity from the first histogram bin.

By “first histogram bin”, it should be understood the first bin (the first class) according to the order of the bins forming the histogram, starting from the bin (class) corresponding to the shortest time-of-flight to the bin (class) corresponding to the longest time-of-flight.

By selecting the first relevant bin of the histogram corresponding to the first reflected photons to be detected, a large portion of the multi-reflected photons is discarded. Thus, the useful signal for determining the desired physical quantity is enhanced, resulting in a better estimation, as illustrated by FIG. 7 discussed hereinbelow.

According to a second aspect, a time-of-flight measurement system is provided for measuring a physical quantity of a container placed in a detection area, the system comprising: a time-of-flight sensor configured to generate a matrix of histograms from a light pulse emitted by a time-of-flight sensor and reflected by the container, each histogram being formed of classes so-called “bins” corresponding to distinct times of flight, and a processor configured to receive the matrix of histograms, to extract, for each histogram, a first histogram bin to indicate a pulse rising edge, so as to obtain a matrix of first histogram bins, and to determine the physical quantity from the matrix of first histogram bins.

The device has the same advantages as those of the aforementioned method. In particular, it allows monitoring a beverage dispenser. Also, according to a third aspect, a beverage dispenser is provided comprising an area for positioning a container to dispense therein a beverage and a time-of-flight measurement system as described hereinabove. In particular, the beverage dispenser has a mechanism for controlling the dispense of beverage in the container which is monitored by a physical quantity of the container determined by the time-of-flight measurement system.

Optional features of embodiments are defined in the appended claims. Some of these features are explained hereinbelow with reference to a method, while they could be transposed into device features.

In one embodiment, a plurality of histograms, forming a matrix, generated from the light pulse is received, each histogram being formed of bins corresponding to distinct times of flight, a first histogram bin that indicates a pulse rising edge is extracted from each histogram, so as to obtain a matrix of first histogram bins, and he physical quantity is determined from the matrix of first histogram bins.

This matrix-based approach could rely on a multi-area ToF sensor, enabling in particular the calculation of physical quantities relating to two dimensions, such as the diameter of the container, or its position in the detection area.

In one embodiment, the method comprises modifying the first histogram bin by interpolation between the extracted first bin (corresponding to a first time-of-flight) and the bin preceding it in the histogram (corresponding to a second time-of-flight).

In the case of a matrix of histograms (multi-area ToF sensor), the matrix of first histogram bins is modified by interpolation between each extracted first bin and the bin preceding it in the same histogram. Thus, a modified matrix of first bins is obtained.

By “bin preceding it”, it should be understood the bin (class) immediately preceding the first bin (class) in the order of the bins (classes) forming the histogram.

The interpolation allows refining the value of the bin (according to the abscissa axis of the histogram) to obtain one or more accurate bin(s). For example, the first bin of the histogram may be an integer, and the interpolation allows obtaining a more accurate decimal value.

In one embodiment, the interpolation comprises a linear interpolation dependent on a first bin threshold used to identify the first bin of the histograms, and dependent on the respective amplitudes of the first bin and of the bin preceding it.

In one embodiment, the determination of the physical quantity comprises converting the extracted first bin into a height of the container or a filling height of the container.

In the case of a matrix of histograms (multi-area ToF sensor), the determination of the physical quantity comprises selecting the minimum value in the matrix of first histogram bins and converting the selected minimum value into a height of the container or a filling height of the container. The time-of-flight corresponding to the extracted/selected bin could then be converted into a distance. Alternatively, the conversion is carried out before the selection. The obtained distance may be subtracted from an initial distance (for example, the distance at the surface of the detection area) to obtain a height (of the cup or of filling for example).

In one embodiment, the determination of the physical quantity comprises: converting the matrix of histograms into a matrix of rising edges identifying bins or times of flight or distances corresponding to the rising edge of the pulse (typically detected at 50% or 60% of the pulse peak) in the histograms, generating two binary matrices corresponding respectively to a matrix signaling the bins or times of flight or distances of the matrix of rising edges that are lower than a first threshold value and a matrix signaling the bins or times of flight or distances of the matrix of rising edges that are higher than a second threshold value, generating a third binary matrix signaling the bins or times of flight or distances corresponding to the bins of the matrix of first histogram bins that are lower than a third threshold value, and determining a circle (or any other predefined shape) in the matrix of histograms, from the three binary matrices.

Thus, it is possible to obtain the diameter of the container as well as its position (for example its center) in the detection area. The knowledge of the diameter (in addition to the height) typically allows estimating the amount of product to be poured, and indirectly the amount of coffee, tea or the like that should be infused in the case of a beverage. Similarly, the knowledge of the position of the container allows determining for example the nozzles to be used to pour the product without any losses. Thus, an improved automation of product/beverage dispensers could be achieved.

In a particular embodiment, the determination of the physical quantity further comprises: determining a distortion value for each histogram of the matrix of histograms, the determination of a distortion value depending on the three bins corresponding respectively to the pulse peak, to the rising edge of the pulse and to the falling edge of the pulse, and generating a fourth binary matrix signaling the histograms having a low distortion value (i.e., below a distortion threshold value), in which method the determination of the circle (or any other predefined shape) also depends on the fourth binary matrix.

In particular, the Inventors have noticed that the histograms corresponding to the rim of the container have an unexpected shape. Thus, taking the distortion of the histograms into account contributes to a better detection of the dimensions and position of the container.

In one embodiment, the method comprises receiving a histogram generated by the time-of-flight sensor, subtracting a reference histogram from the received histogram to obtain a difference histogram, in which method the extraction is performed on the difference histogram.

In the case of a matrix of histograms (multi-area ToF sensor), the method comprises a matrix of histograms generated by the time-of-flight sensor, subtracting a matrix of reference histograms from the received matrix of histograms to obtain a matrix of difference histograms, in which method the extraction is performed on the matrix of difference histograms.

This arrangement allows suppressing interfering elements, from the analysis, which might alter the physical quantity to be measured. Also, filtering by differences is carried out.

The reference histogram or the matrix of reference histograms may typically be acquired beforehand by the time-of-flight sensor.

For example, an image (histogram or matrix of histograms) of the detection area may be acquired before placing the container therein. Thus, it is possible to suppress, in the histograms, the detection signal of the rear wall of a beverage dispenser present in the detection area, or any other element in presence. Thus, the height of the container could be determined more accurately.

In another example described later on, an image (histogram or matrix of histograms) of the empty container in the detection area may be acquired before proceeding with filling thereof. Thus, it is possible to suppress, in the histograms, the detection signal of the container (empty). Thus, the filling height of the container could be determined more accurately.

Also, in another example, an image (histogram or matrix of histograms) of the container in the detection area wherein filling has started may be acquired before carrying on filling. Thus, it is possible to suppress, in the histograms, the detection signal of the container (empty) as well as that one of any reflections specific to the poured product and that one resulting from the filling jet. Thus, the filling height of the container could be determined in real-time with a better accuracy.

In one embodiment, the extraction of the first bin of a histogram comprises: obtaining a first bin threshold dependent on a pulse peak of the histogram. By “pulse peak”, it should be understood the maximum amplitude of the bins of the histogram, and determining the first bin, in the order of the bins of the histogram, whose amplitude exceeds the first bin threshold.

Thus, the start of the rising edge of the reflected pulse, which is the portion the most likely to correspond to the desired distance, is identified.

In one embodiment, the first bin threshold is determined from a predefined percentage of the pulse peak of the histogram.

According to a particular embodiment, the method comprises determining an ambient noise threshold during the light pulse (typically carried out by the ToF sensor just before or after the pulse, between two consecutive pulses), the first bin threshold being set at least equal to the ambient noise threshold. The ambient noise corresponds to the resultant signal of the photons of ambient lighting, independently of the measurement light pulse emitted by the ToF sensor.

In particular, an ambient noise may be determined for each sub-area in the case of a multi-area ToF sensor, and therefore for each histogram of the matrix of histograms.

Thus, with the arrangement hereinabove, the bins (classes) that are likely to reflect only ambient noise are filtered.

In one embodiment, the extraction of the first bin of the histogram further comprises one or more processing operation(s) among: ignoring, in the histogram, a pulse whose width is smaller than a width threshold. Typically, the width of a pulse may be determined by the width between half (or 60% or any other value) the rising edge and half (or 60% or other) the falling edge, and ignoring, in the histogram, a bin whose amplitude is lower than a predetermined noise threshold for this bin.

Thus, parasitic pulses or pulses resulting from noise could be discarded from the analysis.

These processing operations may be implemented for each histogram in the case of a matrix of histograms (multi-area ToF sensor).

In a particular embodiment, the method comprises: determining, for each bin of the histogram, a current noise threshold from the amplitude of the corresponding bin in the histogram and a current ambient noise measurement, determining, for each bin of the histogram, a reference noise threshold from the amplitude of the corresponding bin in a reference histogram and a reference ambient noise measurement, and obtaining a predetermined noise threshold for each bin, by adding the current noise threshold and the reference noise threshold determined for this bin.

These operations may be implemented for each bin of each histogram in the case of a matrix of histograms (multi-area ToF sensor).

The measurement of the current ambient noise is typically carried out concomitantly with (for example, just before or just after) the acquisition of the histogram (or of the matrix of histograms). Similarly, the measurement of the reference ambient noise is preferably carried out concomitantly with an acquisition of the reference histogram (or of the reference matrix).

### BRIEF DESCRIPTION OF THE DRAWINGS

Other advantages and features of the invention will become apparent upon examining the detailed description of non-limiting embodiments and implementations, and from the appended drawings wherein:

FIG. 1 illustrates a time-of-flight telemetry system;

FIG. 2 illustrates one of the histograms of a matrix generated by a ToF imager;

FIG. 3 illustrates a flowchart of a method according to an embodiment;

FIG. 4 illustrates an embodiment for determining one or more physical quantities related to a container;

FIG. 5 illustrates another embodiment for determining one or more physical quantities related to a container;

FIG. 6 illustrates yet another embodiment for determining one or more physical quantities related to a container;

FIG. 7 illustrates enhanced accuracy on an embodiment in determining a height of multiple containers; and

FIG. 8 illustrates a hardware architecture of a processing unit for carrying out disclosed methods.

For clarity, the same elements bear the same references in the different figures. Moreover, the various figures are not plotted to scale, as is usual in the representation of integrated circuits.

### DETAILED DESCRIPTION OF ILLUSTRATIVE EMBODIMENTS

The present invention will be described in the context of time-of-flight (ToF) telemetry systems and, in particular embodiments, of the ToF telemetry system capable of accurately estimating physical quantities related to a container arranged in a detection area.

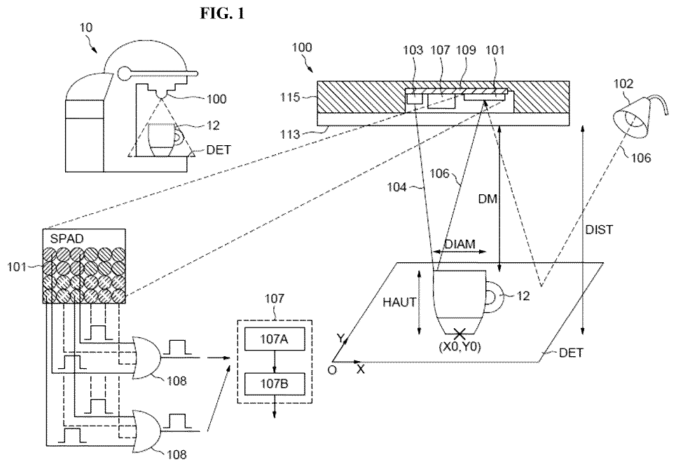

FIG. 1 illustrates a time-of-flight (ToF) telemetry system 100, in one embodiment. Such a ToF system 100 may be implemented within a product dispenser in a container.

As illustrated in the figure, a beverage dispenser, herein a coffee machine 10, is provided with a ToF telemetry system 100 for estimating physical quantities of a container herein a cup 12, arranged in the detection area DET having a reference frame (O,X,Y) and whose surface is located at a distance DIST from the ToF system 100. This distance may be initially measured by the ToF system 100 or preprogrammed.

For simplicity, not all of the features of the ToF telemetry system 100 will be illustrated. Furthermore, to facilitate the discussion, FIG. 1 illustrates a container 12 (for example, a cup) and an ambient source 102, it being understood that the container 12 and the ambient source 102 are not part of the ToF telemetry system 100.

The part to the right in FIG. 1 illustrates the sectional view of the ToF telemetry system 100, whereas the lower part to the left of the figure illustrates the details of some components of the ToF telemetry system 100, such as a bottom view of the SPAD array 101, the output pulses (for example, indicating the avalanche current events) generated by the SPADs in the SPAD array 101, the OR combinatorial trees 108 used to combine the output pulses, and details of the processing unit 107.

As illustrated in FIG. 1, the ToF telemetry system 100 comprises a SPAD array 101, a light source 103 (also so-called emitter) and a processing unit 107 fastened to a substrate 109 (for example, a printed circuit board (PCB), an interposer, or the like). FIG. 1 also illustrates an assembly case 115 (for example, a protective case, a box, a shell or the like). The SPAD array 101, the light source 103, the processing unit 107 and the substrate 109 are located inside a space surrounded by the assembly case 115. A protective glass 113 may be fastened at the lower surfaces of the lateral walls of the assembly case 115, thereby forming a closed space to protect the components arranged within the space.

The light source 103 is a circuit configured to generate a light source 104 intended to illuminate the detection area DET and consequently any container 12 located therein. For example, the light source 103 may be a vertical-cavity laser (VCSEL), a light-emitting diode (LED), an infrared (IR) device, or the other. The light signal 104 may comprise a plurality of light pulses. The light signal 106 reflected by the container 12 is received by the SPAD array 101. In practice, an optical lens may be arranged in front of the SPA array 101 to concentrate the light signal originating from different directions towards the SPAD array 101. The latter comprises several SPADs arranged, for example, in rows and columns. The SPAD output signals of the SPAD array 101 are sent to a ToF histogram generation circuit 107A to generate a histogram or a matrix of histograms MATRIX. Methods for generating histograms using a SPAD array are known in the art, and the details are not repeated.

ToF imagers generating histograms or matrices of histograms are known, for example the multi-area ToF sensors commercialized by the ST Microelectronics company under the references VL₅₃L₈CH and VL₅₃L₇CH. The resolution of such sensors can be configured up to 64 sub-areas (8×8 sub-areas) and the resolution of the histograms up to 128 classes over a detection area DET extending up to about 400 cm with a diagonal field of view of 65°. Alternatively, a single-area ToF sensor may be used in some applications.

The classes of a histogram correspond to the cells or groups of intervals, also so-called “bins” by a person skilled in the art, corresponding to abscissa values represented for each bar of the histogram. Next, reference will be made primarily to “bins” to designate these classes.

Each sub-area of a multi-area ToF sensor includes one or more SPAD(s). A matrix of 8×8 histograms may be generated at a frequency comprised between 5 and 60 Hz. Of course, other ToF sensors having a greater or lower number of sensor sub-areas, as well as other operating characteristics, may be used.

In the example of FIG. 1, the ToF histogram generation circuit 107A is part of the processing unit 107. The ToF histogram generation circuit 107A counts the photons received per sub-area by counting the number of signals received at the output of the OR combinatorial tree 108 combining the SPADs of the considered sub-area. The cumulation is performed for each time period corresponding to a bin (class) of the histogram, the result of the cumulation being stored as the amplitude of this bin in the histogram. The set of cumulations grouped together into histograms for the different sensor sub-areas forms the matrix of histograms MATRIX. This matrix may also be viewed as being an “image” of histograms, for example with an 8×8 resolution in the example hereinabove.

In the case of a single-area ToF sensor, one single OR combinatorial tree 108 is used, summing up all of the signals received by all SPADs.

The processing unit 107 also comprises a processor 107B which receives and processes the histogram or the matrix of histograms. For example, the processor 107B may be a microcontroller, a digital signal processor (DSP) an application-specific integrated circuit (ASIC), or other. The processor 107B processes the matrix of histograms to extract useful information therefrom, such as measurements of physical quantities related to the container 12, as described later on. To this end, the processor 107B is configured to execute one or more method(s) disclosed hereinafter in order to estimate, for example, the height of the container 12, its diameter, its position in the reference frame (O,X,Y), the level of filling thereof with beverage (or, equivalently, the filling height).

In particular, as it will become clear later on, the determination of the height of the container or the filling level may comprise determining the distance of a closest target (for example, the upper rim of the container 12 or the level of the liquid poured in an “image” of histograms in which the signal related to the container 12 has been suppressed) with respect to the ToF telemetry system 100. In some cases, the ToF histogram generation circuit 107A and the processor 107B are integrated in the same semiconductor chip (for example, in one single integrated circuit chip). In other embodiments, the ToF histogram generation circuit 107A and the processor 107B are formed in different (for example separate) semiconductor arrays.

The measurements of physical quantities obtained by the processor 107B may be exploited thereby or transmitted to a dispense controller (not shown), in order to generate commands intended for monitoring the dispense of a product in the container 12, for example pouring of a beverage in the cup 12 by the dispenser 10.

For illustration, the preparation of an appropriate amount of beverage to be poured (both in terms of the volume to be delivered and of the raw materials to be used—for example the amount of powder to be mixed, coffee or tea to be infused) may be automatically monitored according to a measurement of the height of the cup 12 obtained according to the teachings of the present document, but also a diameter of the cup 12 also obtained according to the teachings of the present document.

Similarly, stopping pouring of the beverage may be automatically monitored according to the filling level of the cup 12 (and therefore the height of the liquid with respect to the height of the cup) obtained according to the teachings of the present document. Also, the activation, or not, of pouring in case of proper positioning of the cup 12, or the activation of some beverage delivery nozzles, may be automatically monitored according to a positioning of the cup 12 obtained according to the teachings of the present document.

The components used to emit light pulses, receive the reflected light pulses and generate the matrix of histograms, which comprise the light source 103, the SPAD array 101 and the ToF histogram generation circuit 107A, are referred to together as ToF imager (also so-called ToF sensor), in some embodiments. Consequently, the ToF telemetry system 100 comprises the ToF imager and the processor 107B, and the processor 107B processes the matrix of histograms MATRIX generated by the ToF imager.

The determination of the height of the container or of the filling level may be carried out using one single histogram. Also, a single-area ToF sensor may be used for such an application.

The determination of the diameter of the container as well as its position in the detection area requires a matrix of histograms. Also, a multi-area ToF sensor is used for such an application.

In the remainder of the document, reference is primarily made to a multi-area ToF sensor (and therefore a matrix of histograms). Nevertheless, a person skilled in the art is capable of applying the following teachings to one single histogram, generated by a single-area ToF sensor.

FIG. 1 illustrates the light source 103, the SPAD array 101, and the processing unit 107 as distinct components fastened to the substrate 109. This is just a non-limiting example. In some embodiments, the light source 103, the SPAD array 101 and the ToF histogram generation circuit 107A are integrated into one single integrated circuit in the form of an integrated ToF imager. In some embodiments, the light source 103, the SPAD array 101, the ToF histogram generation circuit 107A and the processor 107B are integrated into one single integrated circuit as an integrated ToF telemetry system.

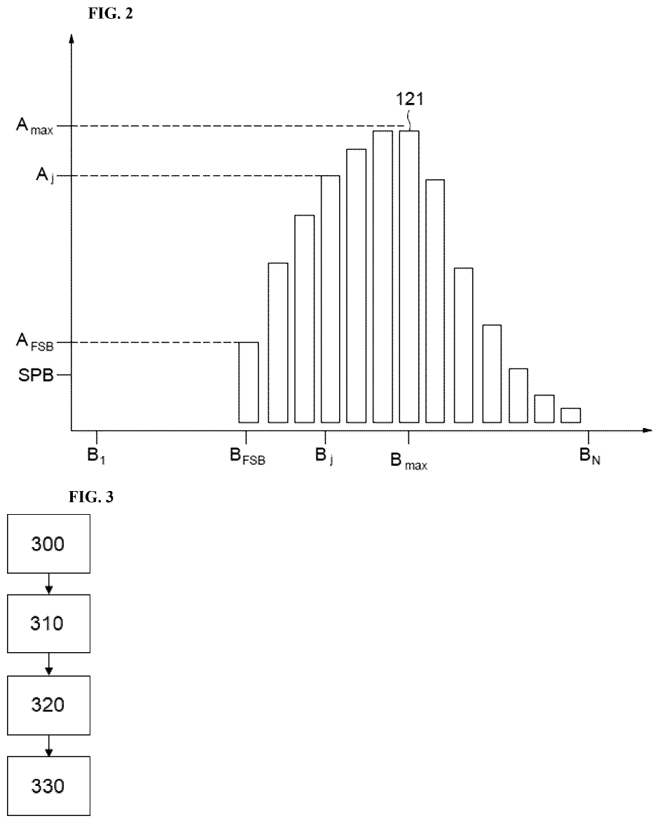

FIG. 2 illustrates one of the histograms of the matrix MATRIX generated by a ToF imager, in one embodiment. The histogram of the example of the figure includes several bins or classes (also so-called histogram bins or classes), denoted B₁ to B_{N} (N being the number of bins). The value or amplitude of each class (for example, along the ordinate axis) of the histogram, denoted A₁ to A_{N}, represents the number of signals for a duration (for example, a fixed duration) of the bin. The location ‘j’ (for example, along the abscissa axis), or the index position or number, of each bin of the histogram corresponds to a time-of-flight and therefore to a distance D₁ to D_{N} (or to a narrow range of distances) with respect to the SPAD array 101. It should be noted that the time-of-flight represents the round-trip time of the light signal. Thus, the distance Dⱼ represents half the distance travelled during the time-of-flight.

During the processing of each histogram of the matrix MATRIX, when a target (the upper rim of the container 12, or the level of filling with liquid) is identified as being located in a bin Bⱼ of the histogram, the distance Dⱼ of this bin of the histogram may be used as the distance of the target (for example, the distance between the SPAD array 101 and the target). In the present document, it is assumed that the light source 103 and the SPAD array 101 are located at the same location, so that the distance between the SPAD array 101 and the target is considered to be identical to the distance between the light source 103 and the target.

To facilitate the discussion, a distance Dⱼ is assigned to each bin Bⱼ of each histogram (for example, a distance corresponding to the center of the bin), and the distance corresponding to a bin is also so-called the bin distance. The index ‘j’ of the location or position, also so-called the bin index or number, may be used to indicate the distance of the location. For example, assuming that the first bin (for example, the leftmost or the most ancient bin) of the histogram has a 1 index, the second bin has a 2 index, and so on, the distance of the j-th bin may be calculated as ((j−1)+0,5) d, where d is the distance travelled by the light signal over a time period equal to half a time interval T, and the time interval T is the duration of one bin of the histogram. The time interval T is also so-called the bin time width, and the distance d is also so-called the bin width.

Preferably, all of the histograms of the matrix MATRIX are formed with the same bins. Alternatively, different bins may be used. Similarly, within the same histogram, the bins preferably have the same width, but could alternatively differ from each other.

In the example of FIG. 2, the histogram comprises one single peak 121, which might be caused by the presence of the container 12 in the detection area DET.

FIG. 3 illustrates, through a flowchart, steps of a method according to some embodiments. For example, these steps are implemented by the processor 107B, intended for the measurement of at least one physical quantity of a container, such as the cup 12 of FIG. 1, placed in a detection area DET, using a time-of-flight sensor such as the ToF imager 100 of FIG. 1.

This method may be carried out as new images are acquired by the ToF sensor, for example at a frequency comprised between 5 Hz and 60 Hz.

The method comprises, inter alia, a step (300) of receiving a matrix of histograms, for example the matrix MATRIX hereinabove, generated from a light pulse emitted by the time-of-flight sensor 100 and reflected by the container 12, each histogram (like the one of FIG. 2) being formed of bins or classes Bⱼ corresponding to distinct times of flight. It also comprises a step of extracting (310), histogram-by-histogram, a first histogram bin, denoted BFSB or FSB (first significant bin) later on, the first one that indicates a pulse rising edge, so as to obtain a matrix of first histogram bins, denoted MFSB. In the bins ordered B₁ to B_{N}, the first one that indicates a rising edge is one amongst those at the base of the rising edge, and therefore one amongst those receiving the first reflected photons of the pulse. Thus, we obtain a matrix representing the bins associated with the first received photons by each of the detection sub-areas of the ToF sensor. This matrix of first histogram bins MFSB is more suitable than the conventional matrix obtained from the ToF sensor, to determine (320) the physical quantit(y/ies).

Typically, for an application related to a beverage dispenser, the steps hereinabove, and detailed later on, allow determining or part of the height, the diameter and the position of the container as well as the height of filling (or rate of filling) of the latter with beverage.

The physical quantit(y/ies) thus determined may be used (330) in monitoring the automation of the beverage dispenser 10. For example, the activation, or not, of the beverage dispense depending on whether the container is properly positioned, or not, in the detection area DET. The determination of a volume of beverage to be delivered (and indirectly the amount of raw material—tea or coffee for example—required for the production of the beverage volume) according to the height of the container and possibly its diameter. Stopping pouring of the beverage by the dispenser 10 when the container 12 is filled enough.

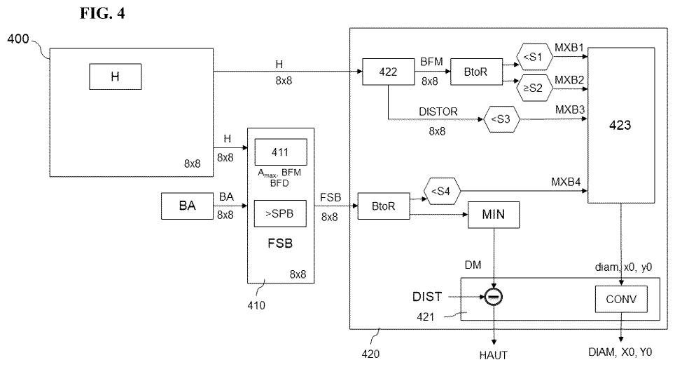

FIG. 4 illustrates a first embodiment of operations carried out by the processor, for example the processor 107B, for the determination of one or more physical quantit(y/ies) related to the container 12, in particular its height, its diameter and its position in the detection area DET.

The processor comprises a block (means or operations) 400 for obtaining the matrix of histograms MATRIX, a block (means or operations) 410 for extracting the FSB per histogram and thus obtaining the matrix MFSB and a block (means or operations) 420 for determining the physical quantit(y/ies) from the matrix MFSB.

In the illustrated embodiment, obtaining 400 the matrix of histograms MATRIX may just consist in receiving the matrix MATRIX of the ToF sensor. In the figure, each received histogram is denoted “H”, the processing operations described hereinafter being carried out histogram-by-histogram when the mention 8×8, indicating the dimension of the matrix, is specified. Of course, any dimension of the matrix other than 8×8 may be considered, in particular non-square dimensions (n×m where n+1). In particular, a 1×1 matrix corresponds to one single histogram obtained from the ToF sensor, which is consequently a single-area ToF sensor.

Although not shown, pre-processing operations of the histogram H may be provided for to reduce the noise thereof or to improve its quality given known surrounding elements. For example, a processing for suppressing a dazzling veiling glare may be considered.

Each histogram H is supplied at the input of the block 410 for extracting the FSBs, simply so-called FSB block.

In one embodiment, optionally, the FSB block 410 also receives an ambient noise measurement BA. The ambient noise measurement BA is made by the ToF sensor 100 between two light pulses. Typically, the ToF sensor makes a measurement of the ambient noise substantially at the time of the light pulse (generating the matrix MATRIX), in practice just before the pulse (between the previous pulse and the pulse of the matrix MATRIX) or just after the pulse. In one embodiment, such a measurement is carried out periodically, the last measurement BA available being then used.

The BA measurement may consist in measuring the average level of photons received by each sensor sub-area over a bin duration T. In this case, 8×8 BA measurement are generated and are used respectively when processing the histogram H corresponding to the same sub-areas.

Alternatively, the BA measurement may be unique for all histograms. For example, the result of the acquisition of a sub-area over the duration T may be considered as a BA measurement for the ToF sensor. Alternatively, the amount of acquired photons for the entirety of the sensor divided by the number of sub-areas may be used as a BA measurement for the matrix MATRIX to be processed.

Where appropriate, a formula for converting the amount of acquired photons into a BA measurement may be used.

The extraction of the FSBs of the histograms H comprises, at first, extracting 411 pulse characteristics in each histogram H.

These pulse characteristics typically comprise the peak or maximum amplitude Amax=max {Aⱼ}, the rising edge bin BFM and the falling edge bin BFD (the first rising edges encountered in the case of a plurality of pulses in the histogram). Typically, the (rising or falling) edge bin BF may be determined as that one corresponding to 50% or 60% (or any other significant percentage) of the peak amplitude.

In one embodiment, these rising edge and falling edge bins BFM, BFD allow calculating a pulse width L=BFD−BFM, which corresponds to a duration. A pulse whose width is lower than a width threshold could then be ignored in the histogram. Si so is the case, we switches to the next pulse (in the case where there are several pulses in the histogram).

Similarly, these rising edge and falling edge bins BFM, BFD determined for multiple pulse responses in the histogram may allow identifying the response to the pulse having the largest width, used for the next operations.

The FSB block obtains a first bin threshold SPB dependent on the pulse peak Amax of the histogram. For example, this consists of a predefined percentage k1 (3%, 4% or 5%) of the pulse peak of the histogram.

Nevertheless, in order to filter the ambient noise, the first bin threshold SPB may be set at least equal to an ambient noise threshold, equal to k2*BA (k2>1). This means that SPB=max {k1*Aₘₐₓ, k2*BA}.

Once the threshold SPB has been determined, the FSB block 410 determines the first FSB bin of each histogram H, according to the order of the bins of the histogram, whose amplitude Aⱼ exceeds SPB. If no bin meets the condition, then no bin is returned as a result.

In one embodiment, the FSB block 410 thus produces a matrix MFSB consisting of 8×8 FSBs thus determined.

In another embodiment, the FSB block 410 modifies this matrix of first histogram bins by interpolation between each extracted first bin FSB (which corresponds to a first time-of-flight) and the bin Bᵢ preceding it in the same histogram (and therefore Bᵢ=FSB−1, which corresponds to a second time-of-flight), so as to obtain a modified matrix of first bins. In particular, the bins of the histogram matrix may be integers, while the interpolated values may be decimal values, thereby offering a more accurate matrix of first bins.

For example, we consider the midway time-of-flight between the two classes Bᵢ and FSB (or B_{FSB}).

In another embodiment, the interpolation is a linear interpolation dependent on a first bin threshold used to identify the first bins of the histograms, and dependent on the respective amplitudes of the first bin and of the bin preceding it. Just for illustration, if the first bin corresponds to the value 11 and has an amplitude of 1,500 ((in terms of amount of photons), the preceding bin corresponding to the value 10 and has an amplitude of 1,000, and the SPB threshold amounts to 1,100, the interpolation weighted by the amplitudes (weight of 1,100-1,000 for the preceding bin and weight of 1,500-1,100 for the first bin) gives a first modified or corrected bin of 10.2. In this manner, the modified matrix of first bins is more accurate with regards to the threshold SPB.

Thus, the FSB block 410 returns a modified matrix MFSB consisting of 8×8 modified first bins. The latter feeds the block 420.

The block 420 is then able to determine a height of the container 12 by selecting the minimum value in the received matrix of first histogram bins MFSB. Whether this matrix indicates a bin or an interpolated, possibly corrected, time-of-flight, the selected minimum value corresponds to a measured distance DM.

In one embodiment as illustrated, this selection may comprise at first converting the matrix M_{FSB} into a matrix of distances, by converting each bin (or time-of-flight) into a distance by the BtoR (bin to range) block.

In some embodiments, the conversion into distances allows compensating for/correcting possible errors of calibration of the ToF sensor.

The height HAUT of the container 12 is then obtained, by the conversion sub-block 421 in the reference frame (O,X,Y), by subtracting the measured distance DM from the distance DIST of the surface of the detection area DET.

In parallel, for the determination of the diameter and of the position of the container 12 in the reference frame, a binary matrix MXB4 signaling the bins or times of flight or distances corresponding to the bins of the matrix of first histogram bins M_{FSB} that are lower than a threshold value S4 is generated. Typically, this threshold value S4 is representative of a distance slightly smaller than DIST, for example smaller than 10 to 40 mm.

In this embodiment (determination of the diameter), the block 410 also receives the 8×8 histograms H of the block 400, from which it extracts or determines (sub-block 422) pulse characteristics in each histogram H.

These pulse characteristics comprise the rising edge bin BFM (already described hereinabove). This allows converting the matrix of histograms MATRIX into a matrix of rising edges M_{FM} identifying bins or times of flight or distances corresponding to the rising edge of the pulse in the histograms.

In this matrix M_{FM}, it is possible to generate two binary matrices respectively corresponding to a matrix MXB1 signaling the bins or times of flight or distances of the matrix of rising edges M_{FM} that are lower than a first threshold value S1 and a matrix MXB2 signaling the bins or times of flight or distances of the matrix of rising edges that are higher than a second threshold value S2.

For example, the threshold values S1 and S2 may be selected close to DIST in order to separate the bins corresponding to targets measured above the surface of the detection area DET, bins corresponding to targets measured below (because of the reflection of the light ray in the cup 12).

In one embodiment, S1 and S2 are independent. Their values may be determined empirically or from tests allowing identifying which values offer good results in detecting a container 12 upper rim.

Preferably, the matrices MXB1 and MXB2 are formed from the matrix of rising edges M_{FM} converted into distances (BtoR block).

In one embodiment, the pulse characteristics may also comprise the pulse peak bin Bₘₐₓ, the falling edge bin BFD (already described hereinabove) and a pulse distortion measurement DISTOR to indicate the distortion level of the received pulse response. Indeed, it has been noticed that the histograms corresponding to the rim of the container have an unexpected shape. Thus, taking the distortion of the histograms into account contributes to a better detection of the dimensions and position of the container.

Typically, the measurement of the pulse distortion DISTOR may be obtained by the following formula:

$$DISTOR = ( {B}_{max} - BFM ) / ( BFD - BFM ) .$$

It is possible to consider that a measurement DISTOR lower than 75% indicates a distorted response to the pulse.

Thus, a distortion value DISTOR is determined for each histogram H of the matrix of histograms MATRIX, the determination of a distortion value depending on the three bins respectively corresponding to the pulse peak Bₘₐₓ, to the rising edge of the pulse BFM and to the falling edge of the pulse BFD.

These 8×8 measurements DISTOR allow generating another binary matrix MXB3 signaling the histograms having a low distortion value (i.e., below a distortion threshold value S3).

Thus, the four binary matrices MXB1 to MXB4 represent four different filtering versions of the matrix MATRIX to characterize the measurements of the container 12 according to four different aspects.

These four matrices (or more generally one to four, depending on which of them are available, some embodiments could generate only some of them) are supplied at the input of a best circle determination module (sub-block 423).

For example, such a module may implement the circle Hough transform (CHT). This consists of a technique for extracting basic features used in digital image processing to detect circles in imperfect images. This technology being known to a person skilled in the art, it is not herein described in more details.

For example, it allows identifying a (better) candidate circle in each of the matrices. The sub-block 423 could then select the best circle amongst the candidates, using any known metrics.

In one embodiment, each matrix MXB1 to MXB4 is analyzed to determine the number of active areas (number of 1 in the matrix). The circle Hough transform is applied on any matrix that has enough active areas (number of 1 greater than a threshold, for example 12 for an 8×8 matrix), so as to identify a candidate circle. If none of the matrices has enough active areas, these could be grouped together (an OR binary operation, sub-area by sub-area) and the circle Hough transform is applied to the resultant matrix.

Thus, the sub-block 423 determines a circle from the binary matrices at the input.

The diameter ‘diam’ and the position xo, yo of the circle thus determined (values in the image MATRIX) are now known.

The conversion sub-block 421 then allows obtaining the diameter DIAM and the coordinates Xo, Yo of the container 12 in the reference frame (O,X,Y) of the detection area DET.

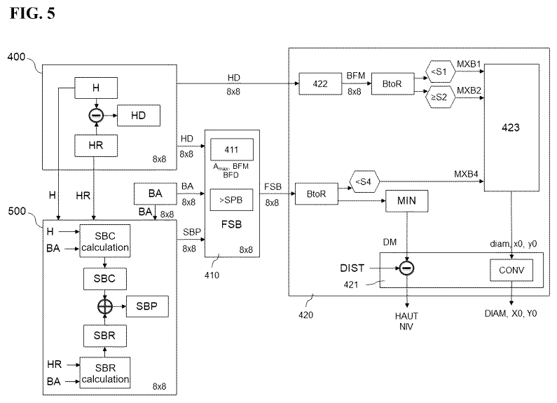

FIG. 5 illustrates a second embodiment of operations carried out by the processor, for example the processor 107B, for the determination of one or more physical quantit(y/ies) related to the container 12.

This second embodiment allows suppressing any interfering object in the field of view FoV (field of view) of the sensor ToF. For example, the rear wall of the dispenser 10 might be detected by the ToF sensor and could affect the accuracy of the measurement of the height of the cup 12, in particular if a portion of the rear wall is located closer to the sensor than the top of the cup 12.

Similarly, the cup 12 itself could affect the accuracy of the measurement of the filling height of the cup 12 (and therefore the height of the liquid that has been poured therein).

In this context, the second embodiment provides for recording a reference image before the presence of the target (either the cup 12, or the beverage that has been poured therein), and using it as an a priori knowledge in order to correct an acquired current image, typically in order to subtract it from the current image. In other words, a matrix REF_{MATRIX} of reference histograms HR is subtracted from the received matrix of histograms MATRIX to obtain a matrix DIFF_{MATRIX} of difference histograms HD. The extraction of the FSBs is then performed in these difference histograms HD. To this end, the block 400 for obtaining the matrix of histograms comprises a histogram subtraction module: HD=H−HR.

The matrix REF_{MATRIX} of reference histograms HR is acquired beforehand (before the matrix MATRIX being processed) by the time-of-flight sensor 100. Hence, the data of the histograms are temporarily stored by the processor 107B.

In particular, these may consist of a matrix MATRIX acquired beforehand of the detection area before placing the cup 12 therein. Preferably, such a configuration is used for the determination of the height of the cup 12.

Alternatively, these may consist of a matrix MATRIX (acquired beforehand) of the empty cup in the detection area, before proceeding with filling thereof. Preferably, such a configuration is used to measure the filling height of the cup.

In one variant enabling an even more accurate measurement of the filling height of the cup, these may consist of a matrix MATRIX (acquired beforehand) of the cup in the detection area in which filling has already started and before carrying on filling. For example, this matrix may correspond to that one acquired within a few tenths of a second after triggering of pouring of the beverage or when a predetermined level of product/liquid (for example, 10 mm) has already been poured. Indeed, such a configuration allows attenuating, in the matrix DIFF_{MATRIX} analyzed afterwards, both the presence of the cup 12 and the reflections of the liquid at the bottom of the cup, but also the signal resulting from the filling jet (present in the field of view of the ToF sensor).

Henceforth, what has been described with reference to FIG. 4 may apply to the difference histograms HD to obtain a height HAUT of the cup 12, its diameter DIAM and its position Xo, Yo in the reference frame (O,X,Y).

It should be noted that the binary matrix MXB3 may be omitted to the extent that the subtraction of histograms substantially modifies the shape of the analyzed histogram.

In one embodiment, the processor 107B includes a block (means or operations) 500 for obtaining bin noise thresholds. These thresholds are calculated, for each histogram H, from this histogram H, from the corresponding reference histogram HR (i.e., corresponding to the same sensor sub-area in the reference matrix REF_{MATRIX}) and from the ambient noise BA (already mentioned hereinabove).

In details, the block 500 could, on the one hand, calculate a bin current noise threshold SBC(H, Bⱼ) for each bin of each sensor sub-area, i.e., for each bin Bⱼ of each histogram H. The threshold SBC(H, Bⱼ) is calculated from the amplitude of the corresponding bin Aⱼ in the histogram H and from the current ambient noise measurement BA (possibly per sub-area), for example:

$$SBC ( H , {B}_{j} ) = {k}_{3} * √ ( BA ) + {k}_{4} * {A}_{j} ,$$

where √ is the root square, and k₃ and k₄ are two parameters, k₃ corresponding to an ambient noise scale factor (for example, k₃=1.4) and k₄ corresponding to a signal scale factor (for example, k₄=0.1).

On the other hand, the block 500 calculates a class reference noise threshold SBR(H, Bⱼ) for each bin of each sensor sub-area, i.e., for each bin Bⱼ of each reference histogram HR. The threshold SBR(HR, Bⱼ) is calculated from the amplitude of the corresponding bin Aⱼ in the reference histogram HR and the reference ambient noise measurement BA (possibly per sub-area). The same formula as hereinabove may be used, only the considered amplitude Aⱼ (herein in the reference histogram HR) varying.

A predetermined noise threshold for each bin SBP(H, Bⱼ) may then be determined by adding the current noise threshold SBC(H, Bⱼ) and the reference noise threshold SBR(HR, Bⱼ) determined for this class, namely SBP(H, Bⱼ)=SBC(H, Bⱼ)+SBR(HR, Bⱼ).

These predetermined noise threshold (N×8×8 in number for N bins per histogram and 8×8 sensor sub-areas) SBP(HR, Bⱼ) are temporarily stored by the processor 107B and supplied at the input of the FSB block 410 which takes them into account in the extraction of the first pulse rising edge bins.

In one embodiment, the FSB block 410 may ignore, in the processed histogram H, a bin Bⱼ whose amplitude Aⱼ is lower than the predetermined noise threshold for this bin SBP(H, Bⱼ).

For example, when searching for the widest pulse response in the histogram H, it may be provided to take account only of the bins whose amplitude is higher than their associated threshold SBP(H, Bⱼ).

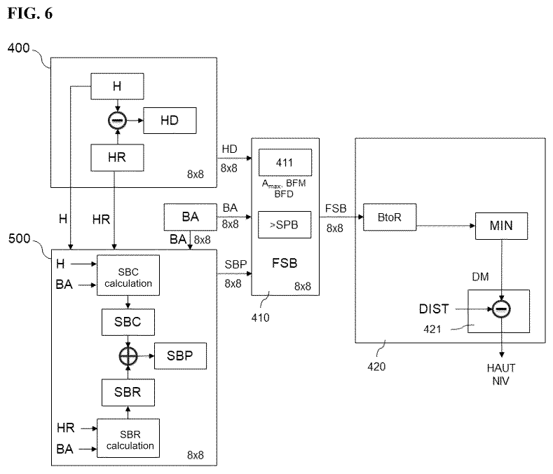

FIG. 6 illustrates a third embodiment of operations carried out by the processor, for example the processor 107B, for the determination of one or more physical quantit(y/ies) related to the container 12. This is a simplified version of the second embodiment, particularly suited to the measurement of a height (either of the container, or of filling).

Therefore, the determination of the matrices MXB1 to MXB4 and the use thereof to obtain the diameter DIAM and the position (Xo, Yo) of the container 12 are omitted.

Hence, a first execution of the operations of the Figure allows obtaining a measurement of the height HAUT of the cup 12.

A second execution of the operations of the Figure allows obtaining a measurement of the height NIV of filling of the cup 12 with the liquid delivered by the dispenser 10.

The second execution may immediately follow the first execution. Hence, the processor 107B acquires the height of the cup 12, may control the dispense of a beverage in the cup 12 and stop the dispense when the filling level NIV reaches a predefined value, for example 80% of the height of the cup 12.

Alternatively, the second execution may follow an execution of the second embodiment of FIG. 5 during which the diameter ‘diam’ (or DIAM in the reference frame (O,X,Y) and the position (xo, yo) (or Xo, Yo) of the container 12 are measured.

In this variant, it is possible to reduce the processing operations of this second execution by limiting the selection of the minimum value (by the block 420) only to the sensor sub-areas located at least partially within the circle with the center (xo, yo) and with the diameter ‘diam’.

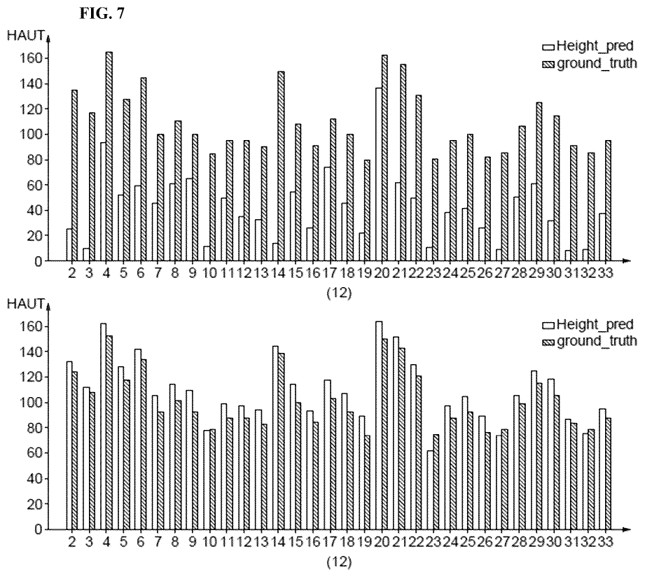

FIG. 7 illustrates the enhanced accuracy in the determination of the height HAUT of thirty-three containers 12.

The graph at the top shows the heights HAUT measured by the conventional use of a ToF sensor (the bar to the left in each pair of bars) next to the actual heights (the bar to the right). One could observe an excessive over-estimation of the distances between the ToF sensor and the upper rim of the containers 12, leading to an excessive under-estimation of their height.

The graph at the bottom illustrates the heights HAUT measured by the user of a ToF sensor using the above-described matrix M_{FSB}, next to the actual heights. One could observe a significant improvement of the measurement.

Hence, an improved monitoring of the automation of beverage dispensers may be obtained.

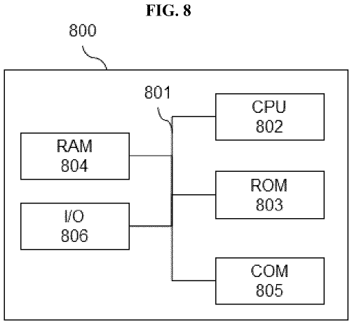

FIG. 8 illustrates a hardware architecture for the processing unit 107 of FIG. 1. It comprises a communication bus 801 to which are preferably connected:
one or more central processing unit(s) 802, such as one or more CPU processor(s) and/or one or more microprocessor(s);
a ROM-type and/or flash-memory-type storage memory 803, for storing computer programs intended to be implement all or some of the above-described operations;
a RAM or video RAM (VRAM) type random-access memory 804, for storing the executable code of the computer programs, as well as the registers suitable for recording variables and parameters necessary for execution thereof;
a communication interface or pins 805 connected to the other elements of the sensor, in particular to the OR combinatorial trees 108 combining the SPADs; and
one or more I/O input(s)/output(s) 806 enabling an operator to interact with the computer programs and defining for example operating parameters (for example the parameters k₁ to k₄).

The communication bus 801 ensures communication and interoperability between the different elements included in the processing unit 107 or connected to the latter.

Preferably, the central unit 802 is adapted to monitor and direct the execution of the instructions or software code portions of the computer program(s). Upon switching on, the program(s) which is/are stored in a non-volatile memory 803 is/are transferred/loaded into the random-access memory 804, which then contains the executable code of the program(s), as well as the registers for the storing of variables and the parameters necessary for the implementation of the described methods.

Of course, the present disclosure is not limited to the embodiments described above by way of examples; it extends to other variants. Other embodiments are possible.

What is claimed is:

1. A method comprising, using a processor:
receiving at least one histogram generated from a light pulse emitted by a time-of-flight sensor and reflected by a container located in a detection area, the histogram comprising bins corresponding to distinct times of flight;
extracting, from the histogram, a first histogram bin that indicates a pulse rising edge; and
determining, from the first histogram bin, a physical quantity of the container located in the detection area.

2. The method according to claim 1, further comprising:
receiving a matrix of histograms generated from the light pulse, each histogram comprising respective bins corresponding to the distinct times of flight;
extracting, from each histogram, a respective first histogram bin that indicates a respective pulse rising edge, so as to obtain a matrix of first histogram bins; and
determining the physical quantity from the matrix of first histogram bins.

3. The method according to claim 1, comprising modifying the first histogram bin by interpolation between the extracted first histogram bin and a bin preceding it in the histogram.

4. The method according to claim 3, wherein the interpolation comprises a linear interpolation depending on a first bin threshold used to identify the first histogram bin of the histograms, and depending on respective amplitudes of the first histogram bin and of the bin preceding it.

5. The method according to claim 2, wherein determining the physical quantity comprises selecting a minimum value in the matrix of first histogram bins and converting the selected minimum value into a height of the container or a filling height of the container.

6. The method according to claim 2, wherein the determining the physical quantity comprises:
converting the matrix of histograms into a matrix of rising edges identifying bins or times of flight or distances corresponding to the pulse rising edge in each of the histograms;
generating a first binary matrix signaling bins or times of flight or distances of the matrix of rising edges that are lower than a first threshold value, and a second binary matrix signaling bins or times of flight or distances of the matrix of rising edges that are higher than a second threshold value;
generating a third binary matrix signaling bins or times of flight or distances corresponding to the bins of the matrix of first histogram bins that are lower than a third threshold value; and
determining a circle in the matrix of histograms, from the three binary matrices.

7. The method according to claim 6, wherein the determination of the physical quantity further comprises:
determining a distortion value for each histogram of the matrix of histograms, the determining the distortion value depending on three bins corresponding respectively to a pulse peak, to the pulse rising edge, and to a pulse falling edge; and
generating a fourth binary matrix signaling the histograms having a low distortion value;
the determining the circle further depending on the fourth binary matrix.

8. The method according to claim 1, further comprising:
receiving a histogram generated by the time-of-flight sensor, subtracting a reference histogram from the received histogram to obtain a difference histogram;
the extracting being performed on the difference histogram.

9. The method according to claim 8, wherein the reference histogram is acquired beforehand by the time-of-flight sensor from among:
a histogram of the detection area before placing the container therein;
a histogram of an empty container in the detection area before proceeding with filling thereof; or
a histogram of the container in the detection area in which a filling has started, before carrying on filling.

10. The method according to claim 1, wherein the extracting the first histogram bin of the histogram comprises:
obtaining a first bin threshold dependent on a pulse peak of the histogram; and
determining the first histogram bin, in an order of the bins of the histogram, whose amplitude exceeds the first bin threshold.

11. The method according to claim 10, wherein the first bin threshold is determined from a predefined percentage of the pulse peak of the histogram.

12. The method according to claim 10, further comprising determining an ambient noise threshold during the light pulse, the first bin threshold being set at least equal to the ambient noise threshold.

13. The method according to claim 8, wherein the extracting the first histogram bin of the histogram further comprises one or more of:
ignoring, in the histogram, a pulse whose width is smaller than a width threshold; or
ignoring, in the histogram, a bin whose amplitude is lower than a predetermined noise threshold for this bin.

14. The method according to claim 13, further comprising:
determining, for each bin of the histogram, a current noise threshold from the amplitude of the corresponding bin in the histogram and a current ambient noise measurement;
determining, for each bin of the histogram, a reference noise threshold from the amplitude of the corresponding bin in the reference histogram and a reference ambient noise measurement; and
obtaining the predetermined noise threshold for each bin, by adding the current noise threshold and the reference noise threshold determined for this bin.

15. A time-of-flight measurement system comprising:
a time-of-flight sensor configured to generate at least one histogram from a light pulse emitted by the time-of-flight sensor and reflected by a container located in a detection area, the histogram comprising bins corresponding to distinct times of flight; and
a processor configured to:
receive the histogram;
extract, from the histogram, a first histogram bin that indicates a pulse rising edge; and
determine, from the first histogram bin, a physical quantity of the container located in the detection area.

16. The time-of-flight measurement system according to claim 15, wherein the processor is further configured to:
receive a matrix of histograms generated from the light pulse, each histogram comprising respective bins corresponding to the distinct times of flight;
extract, from each histogram, a respective first histogram bin that indicates a respective pulse rising edge, so as to obtain a matrix of first histogram bins; and
determine the physical quantity from the matrix of first histogram bins.

17. The time-of-flight measurement system according to claim 15, wherein the processor is further configured to modify the first histogram bin by interpolation between the extracted first histogram bin and a bin preceding it in the histogram.

18. The time-of-flight measurement system according to claim 15, wherein:
the processor is further configured to receive a histogram generated by the time-of-flight sensor, subtracting a reference histogram from the received histogram to obtain a difference histogram; and
the processor is configured to perform the extraction on the difference histogram.

19. A beverage dispenser comprising:
a time-of-flight sensor configured to generate at least one histogram from a light pulse emitted by the time-of-flight sensor and reflected by a container located in a detection area, the histogram comprising bins corresponding to distinct times of flight;
a processor configured to:
receive the histogram;
extract, from the histogram, a first histogram bin that indicates a pulse rising edge; and
determine, from the first histogram bin, a physical quantity of the container located in the detection area; and
an area for positioning the container to dispense therein a beverage.

20. The beverage dispenser according to claim 19, wherein the processor is further configured to control, in accordance with the determined physical quantity of the container, dispensing of a beverage into the container.
